(19) United States
(12) Patent Application Publication
(10) Pub. No.: US 2017/0341188 A1
(43) Pub. Date: Nov. 30, 2017

(54) SOLDER MATERIAL

(71) Applicant: Panasonic Intellectual Property Management Co., Ltd., Osaka (JP)

(72) Inventors: SHINJI ISHITANI, Hyogo (JP); MANABU GOKAN, Hyogo (JP); TATSUO SASAOKA, Osaka (JP)

(21) Appl. No.: 15/479,141

(22) Filed: Apr. 4, 2017

(30) Foreign Application Priority Data
May 31, 2016 (JP) 2016-109249

(51) Int. Cl. B23K 35/02; B23K 35/26; B23K 1/002

(52) U.S. Cl. CPC B23K 35/025; B23K 1/002; B23K 35/262

(57) ABSTRACT

To provide a solder material capable of performing soldering with high reliability while suppressing materials other than a solder metal to remain inside the solder after the soldering. Coil-shaped carbons are heated by electromagnetic waves by using a solder material in which coil-shaped carbons of 0.5 weight % to 1.5 weight % with respect to a weight of a solder paste are mixed, thereby performing soldering by heating the solder material itself.

### TECHNICAL FIELD

The technical field relates to a solder material used when an electronic component, a semiconductor device and a metal bonding material are soldered.

### BACKGROUND

In recent years, the progress in power devices requires a power module responding to large current or high-temperature operation. As a thick copper substrate responding to large current or a high-heat capacity substrate aiming at high discharge, a metal-base substrate using a metal plate as a main material or a bus-bar substrate is used.

A soldering iron or flow soldering by a dip tank is used for soldering between, the metal base substrate or the bus-bar substrate and leads of electronic components in related art. As the metal base substrate and the bus-bar substrate have high heat capacities, heat given for soldering is immediately diffused to the substrate, therefore, a soldering method, considering the heat diffusion is necessary.

In the case of soldering by the soldering iron, the soldering iron sufficiently heated to more than a solder melting point is touched to the metal base substrate or the bus-bar substrate and leads of electronic components to heat them to thereby melt thread solder and perform soldering. However, it is necessary to sufficiently heat the soldering iron to the solder melting point or more in the case of the soldering by the soldering iron, and when the heated soldering iron touches a substrate portion such as a resist on the metal base substrate or the bus-bar substrate, the substrate is burnt and an appearance defect is caused.

In the case of the flow soldering, circular holes are formed in the substrate so that molten solder in the dip tank spreads over bonding portions between a bus bar and leads of electronic components to perform the flow soldering. However, in the case where a low-heat resistance component such as an electrolytic capacitor is mounted, heat is transmitted also to the low-heat resistance component when the heat is transmitted to the bus bar, which may lead to breaking or reduction of lifetime of the low-heat resistance component. Furthermore, in a bus-bar substrate having a three-dimensional structure in which three-dimensional wiring is formed, soldering heights are different, in the same substrate, therefore, it is difficult to perform the flow soldering using the dip tank.

FIG. 8 shows a schematic view of a metal bonding material described in JP-A 2008-112955 (Patent Document 1). In Patent Document 1, bonding by high-frequency induction heating is proposed for a case where a metal component is bonded to a ceramic member or for the case where the substrate is bonded to an electronic component. A metal bonding material 81 of FIG. 8 is formed of a bonding metal 83 and a positioning metal 82, and the positioning metal 82 contains a metal which is not melted at a soldering temperature and can be inductively heated. In the high-frequency induction heating, when a generated electromagnetic wave penetrates through the inside of the positioning metal 82, inductive current is generated in the positioning metal 62. As Joule heat is generated by the inductive current and the positioning metal 82 is heated, the bonding metal 83 is heated and melted to thereby perform soldering. Accordingly, it is not necessary to bring the high-temperature soldering iron into contact, and the appearance defect due to the substrate burning can be prevented. As a soldering process for a short period of time by the inductive heating can be performed also in the soldering with respect to the low-heat resistance component, the soldering can be performed without causing breaking or reduction of lifetime due to immersion of the bus-bar substrate or the leads at a high temperature for a long period of time as in the flow soldering using the dip tank.

### SUMMARY

In the method described in Patent Document 1, the positioning metal 82 remains inside the molten solder as the positioning metal 82 is the metal which is not melted at the soldering temperature. Generally, there exists a difference in linear expansion coefficients between a soldering material used for the bonding metal 83 and the positioning metal 82. For example, a linear coefficient of Sn which is generally used as a main component of the solder material is approximately 23 ppm/°C., a linear coefficient of Ni which is a ferromagnetic material used for the positioning metal 82 is approximately 13 ppm/° C., a linear coefficient of Fe is approximately 14 ppm/° C., and a linear coefficient of Co is approximately 13 ppm/° C. When Ni, Fe and Co as ferromagnetic materials remain in the solder material, a stress is generated inside the metal bonding material 81 due to the difference of linear expansion coefficients between the positioning metal 82 and the bonding metal 83 by repetition of low temperatures and high temperatures in use environment, as a result, there are problems in reliability such as occurrence of a crack at a soldered portion.

The present disclosure has been made for solving the above related-art problems and an object thereof is to provide a solder material capable of realizing the soldering with high reliability while suppressing materials other than the solder metal from remaining inside the solder after the soldering by irradiating the solder material with electromagnetic waves in the case where the electronic component, the semiconductor device and the metal bonding material are soldered.

In order to achieve the above object, a solder material according to an embodiment of the present disclosure is formed by mixing coil-shaped carbons in a solder paste in a proportion of 0.5 weight % to 1.5 weight % with respect to a weight of the solder paste.

As described above, when the electronic component, the semiconductor device, and the metal bonding material are soldered by using the solder material according to the embodiment of the present disclosure, it is possible to perform, soldering with high reliability while suppressing: materials other than a solder metal from remaining inside the solder after the soldering by irradiating the solder material with electromagnetic waves.

### BRIEF DESCRIPTION OF THE DRAWINGS

FIG. 1 is a schematic view of a spider material according to an embodiment of the present disclosure;

FIG. 2 is a schematic view of an irradiation state with electromagnetic waves according to the embodiment of the present disclosure;

FIG. 3 is a schema view of the coil-shaped carbon according to the embodiment of the present disclosure;

FIG. 4 is a graph snowing the relation between a pitch of a coil and heating efficiency according to the embodiment of the present disclosure;

FIG. 5 is a schematic view of soldering by an electromagnetic wave heating device according to the embodiment of the present disclosure;

FIG. 6 is a graph shoving temperature measured values of a solder material by the electromagnetic wave heating according to the embodiment of the present disclosure;

FIG. 7 is a chart showing results of a melting experiment in a proportion, of coil-shaped carbons according to the embodiment of the present disclosure; and

FIG. 8 a schematic view of a metal bonding material described in Patent Document 1.

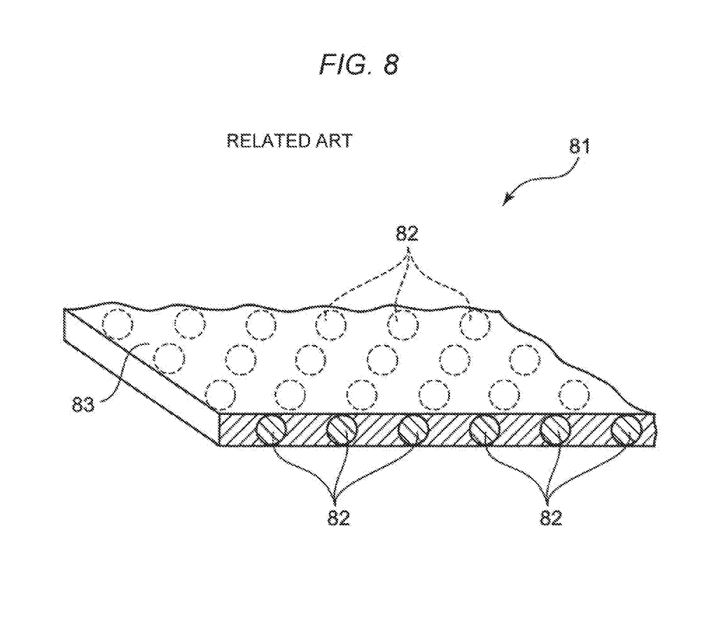

### DESCRIPTION OF EMBODIMENTS

Hereinafter, an embodiment of the present disclosure will be explained with reference to the drawings.

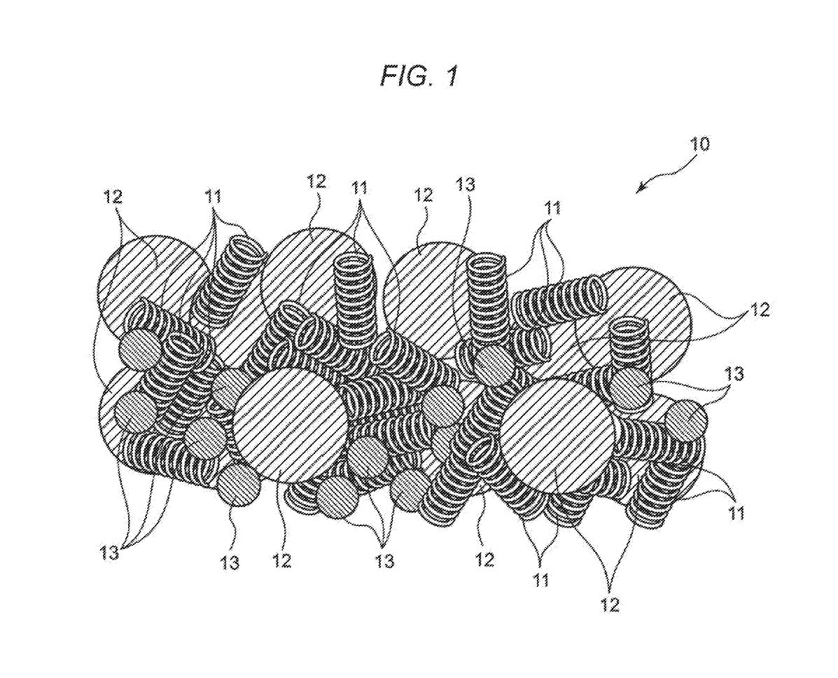

FIG. 1 is a schematic view of a solder material 10 according to the embodiment of the present disclosure.

In FIG. 1, the solder material 10 includes coil-shaped carbons 11, metal particles 12 and flux 13. A related-art solder paste is formed of the metal particles 12 and the flux 13, while the solder material 10 according to the embodiment is formed in a paste state by mixing the coil-shaped carbons 11. A size of the coil-shaped carbon 11 will be described later.

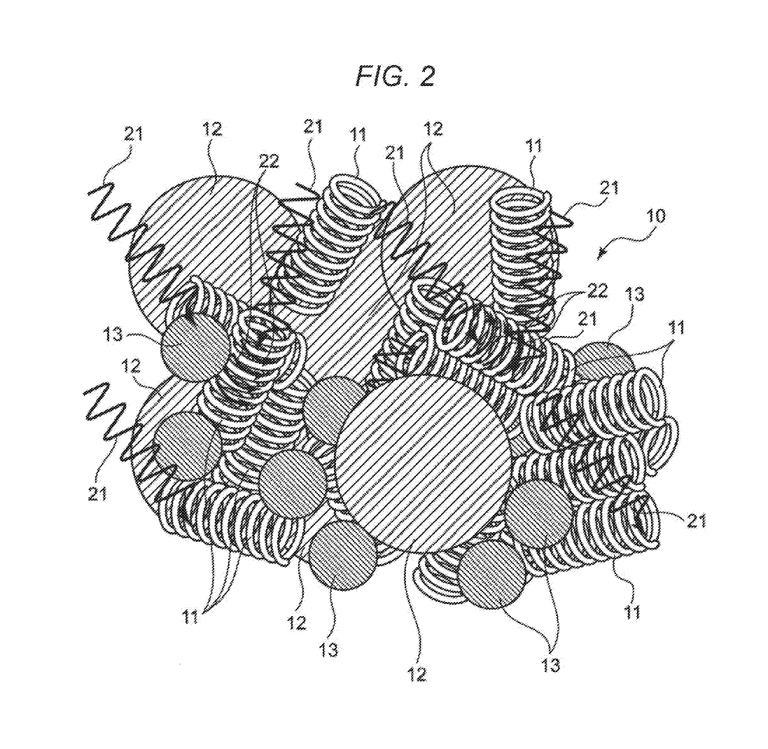

Next, FIG. 2 is a schematic view of an irradiation state of the solder material 10 with electromagnetic waves according to the embodiment of the present disclosure.

A heating principle and a soldering process of the solder material 10 by irradiation of the electromagnetic waves will be explained. In FIG. 2, when the solder material 10 is irradiated with the electromagnetic waves 21, part of the radiated electromagnetic waves 21 penetrates through the inside of the coil-shaped carbons 11. Induction currents 22 are generated in the coil-shaped carbons 11 through which the electromagnetic waves 21 penetrate by the principle of induction heating, and the coil-shaped carbons 11 generate heat by Joule heat due to the induction currents 22. The heat generated in the coil-shaped carbons 11 is transmitted to the metal particles 12 in the solder material 10, and the metal particles 12 are melted when the heat reaches a melting point of the metal particles 12 or more. The metal particles 12 melted at that time spread over substrate electrodes and electronic component terminals to be soldered and are started to be agglutinated by surface tension. The coil-shaped carbons 11 with a small specific gravity are discharged from the molten metal particles 12 and float onto the surface of the solder material 10, therefore, the coil-shaped carbons 11 do not remain inside the solder material 10. When the electromagnetic waves 21 are stopped after that, the induction currents 22 generated in the coil-shaped carbons 11 disappear, the solder material 10 begins to be cooled, and the metal particles 12 are cooled to be a solidifying point or less, then, soldering is completed.

According to the above, the coil-shaped carbon 11 does not remain inside the solder material ID after solidification, and soldering with, high reliability can be realized.

As the coil-shaped carbons 11 are directed not in one direction but in plural directions, in the irradiation of the solder material 10 with electromagnetic waves, the coil-shaped carbons 11 can be heated more efficiently by irradiating the solder material 10 with the electromagnetic waves from plural directions. In order to realize the above, a plurality of irradiation sources for electromagnetic waves are arranged, or radiation of electromagnetic waves from one irradiation source for electromagnetic waves is scattered or reflected, thereby irradiating the solder material 10 with electromagnetic waves from plural directions.

The coils-shaped carbons 11 are mixed in the solder paste for realizing the soldering method described above, and the reason thereof will be described below. The carbon has the coil shape for heating the solder material 10 due to the principle of induction heating as described above in the heating principle. It is necessary that carbon has the coil shape for generating the Induction currents 22 in the carbon by the radiated electromagnetic waves 21. One of the reasons why the material is carbon is an electrical resistivity. An electrical resistivity of Ni as a ferromagnetic material used for the positioning metal 82 of Patent Document 1 is approximately 7.0×10⁻⁸ Ωm, while an electrical resistivity of carbon is approximately 1.6×10⁻⁵ Ωm which is approximately 200 times higher than that of Ni. As described in the above heating principle, the coil-shaped carbons 11 are heated by Joule heat generated when the electromagnetic waves 21 penetrate through the coil-shaped carbons 11, therefore, the electrical resistivity of a heating body is preferably high. Another reason why the material is carbon is a density. A density of Sn as a main component of the solder material is approximately 9.0 g/cm³, while a density of carbon is approximately 1.5 g/cm³ which is six times higher than that of Sn. The difference of densities enables the coil-shaped carbons 11 to be discharged from the molten metal particles 12 when the metal particles 12 are melded in the soldering process.

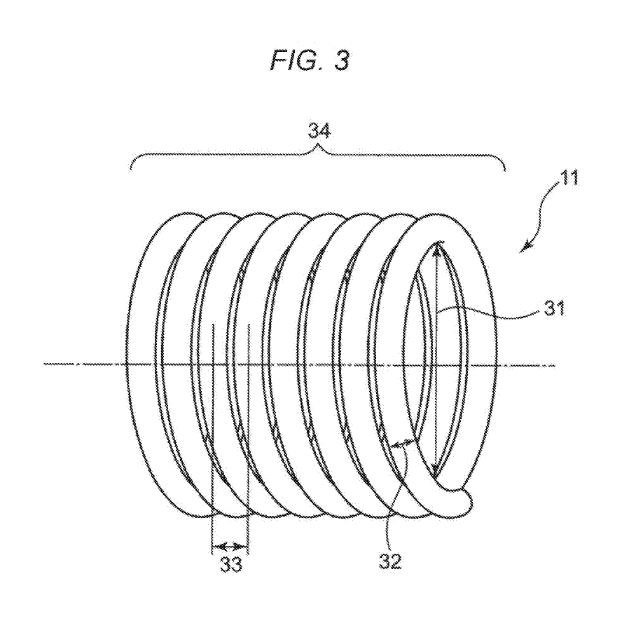

FIG. 3 is a schematic view of the coil-shaped carbon 11 according to the embodiment of the present disclosure.

In FIG. 3, the shape of the coil-shaped carbon 11 is determined by as inner diameter 31, a strand diameter 32, a pitch 33 and the number of turns 34.

In the shape of the coil carbon 11, the number of turns 34 is required to be two or more for making the coil shape according to the heating principle explained by using FIG. 2. In the case where the metal particle 12 enters into the coil-shaped carbon 11, the electronic wave 21 penetrating through the coil-shaped carbon 11 is reflected on the metal particle 12, the induction current 22 is not generated, as a result, heat is not generated. When the inner diameter 31 of the coil-shaped carbon 11 is smaller than a particle size of 10% of the metal particles 12 formed of a metal and alloy powder and having a particle size distribution, the probability that the metal particle 12 enters into the coil-shaped carbon 11 is low, and the heating efficiency is not drastically reduced.

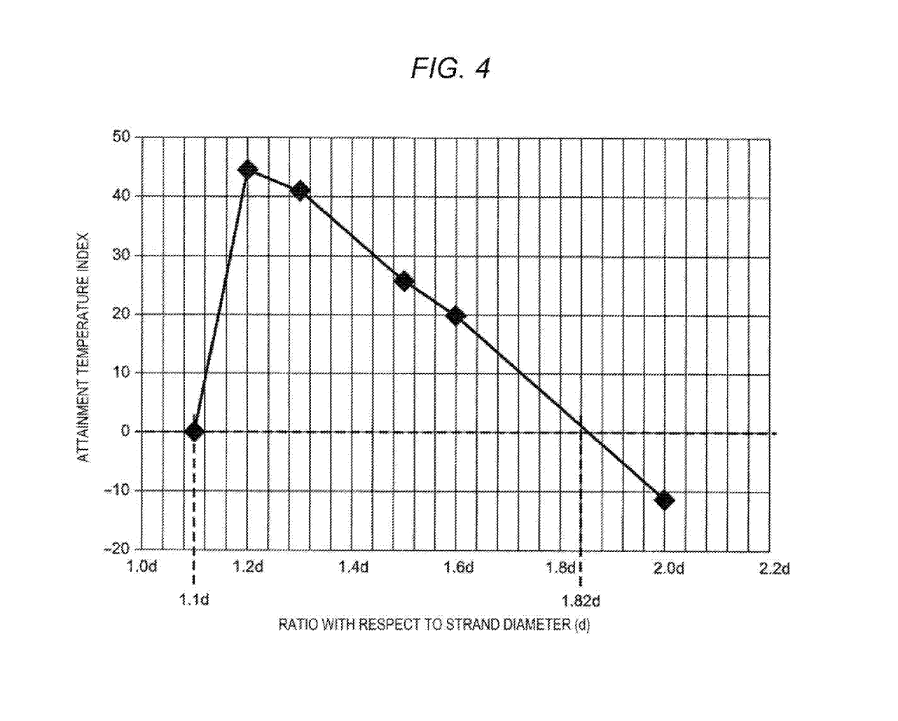

The pitch 33 of the coil-shaped carbon 11 is related to the attainment temperature index by coupled analysis of electronic fields and heat. FIG. 4 is a graph showing the relation between the pitch 33 of the coil-shaped carbon 11 and the heating efficiency according to the embodiment of the present disclosure. As the pitch 33 of the coil-shaped carbon 11 is increased from the minimum pitch as the heat efficiency is increased and reaches an inflection point as the maximum point in the vicinity of 1.2d. When the pitch 33 is further increased, the heating efficiency is reduced and becomes the same heating efficiency equivalent to that of 1.1d in the vicinity of 1.82d. According to the result, the pitch 33 of the coil-shaped carbon 11 is preferably 1.1d≦P≦1.82 when the pitch 33 is P and the strand diameter 32 is “d”.

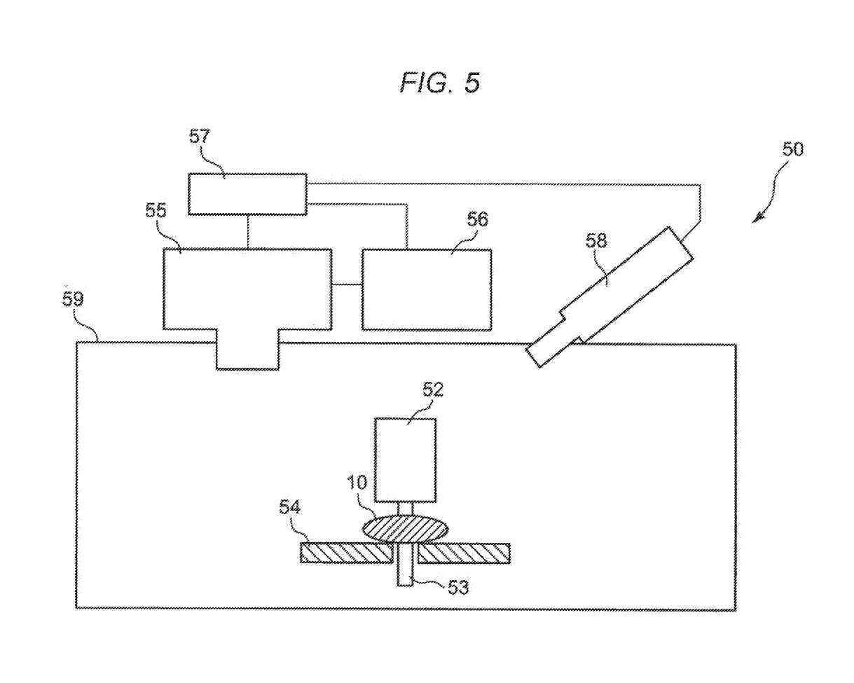

FIG. 5 is a schematic view of soldering by an electromagnetic wave heating device according to the embodiment of the present disclosure.

In FIG. 5, an electromagnetic wave heating device 50 includes an electromagnetic wave generating means 55, an output power detection device 56, a control means 57, a temperature detection means 58 and a shield means 59. When performing soldering, the solder material 10 is supplied to a bonding: portion of the a high-heat capacity substrate 54 and a lead 53 of an electronic component 52 by dispensing or printing, and is set inside the shield means 59 of the electromagnetic wave heating device 50.

After that, a given electromagnetic wave is generated inside the shield means 59 from the electromagnetic wave generating means 55 to thereby heat the solder material 10. The electromagnetic wave heating device 50 is provided with the temperature detection means 58 which measures a temperature of the solder material 10 and an output of the electromagnetic wave generating means 55 is controlled by the control means 57 and the output power detection device 56, thereby heating the solder material 10 and performing soldering between the lead 53 of the electronic component 52 and the high-heat capacity substrate 54 while controlling the output of electromagnetic waves at an arbitrary temperature.

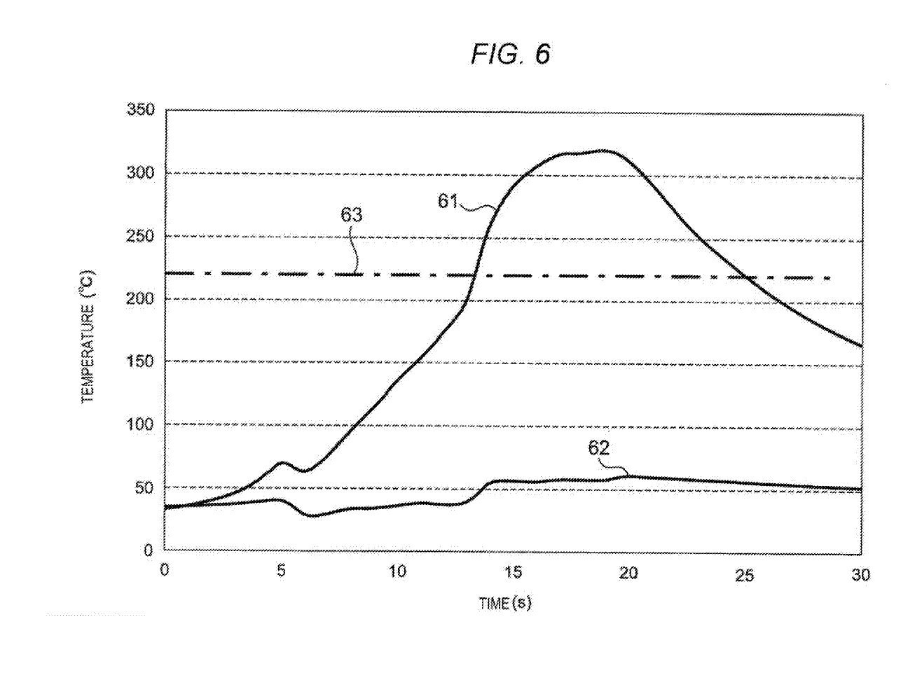

FIG. 6 is a graph showing temperature measured values of the solder material by the electromagnetic wave heating according to the embodiment of the present disclosure. In FIG. 6, the horizontal axis represents the heating time and the vertical axis represents the temperature of the solder material. A temperature measured value 61 indicates temperature measured values of the solder material according to the embodiment of the present disclosure, and a temperature measured value 62 indicates temperature measured values of the solder material in related art. In the embodiment, an experiment was performed by using Sn—Ag—Bi—In as a composition of the metal particles 12 of the solder material 10. The metal particles having a particle size of φ30 μm as an average particle size were used, and irradiation at an output of 800W for 20 seconds was adopted as irradiation conditions of electromagnetic waves. As the coil-shaped carbon 11 as a heat generator does not exist in the related-art solder material indicated by the temperature measured value 62, the increase of temperature is small and does not reach a solder melting point 63 when the solder material is irradiated with electromagnetic waves. In this case, part of the electronic waves 21 is reflected on the surface of the metal particles 12 and does not contribute to heating. When part of the electric waves 21 reaches the flux 13, the solder material is slightly heated by the action of electromagnetic induction, but the temperature does not reach the solder melting point 63. On the other hand, in the temperature measured value 61 of the solder material 10 according to the embodiment of the present disclosure, the solder material is heated by the irradiation of electromagnetic waves the temperature exceeds the solder melting point 63. At this time, part of the radiated electromagnetic waves 21 is reflected on the surface of the metal particles 12 and does not contribute to heating, and the electromagnetic waves 21 reaching the flux 13 slightly heat the material by the action of electromagnetic induction in the same manner as the related-art solder material. When part of electromagnetic waves 21 penetrates the inside of the coil-shaped carbons 11, the induction currents 22 are generated in the coil-shaped carbons, and the coil-shaped carbons 11 are heated due to Joule heat generated at that time, then, the heat is transmitted to the metal particles 12 and the temperature measured value 61 exceeds the solder melting point 63, thereby realizing soldering by the solder material 10.

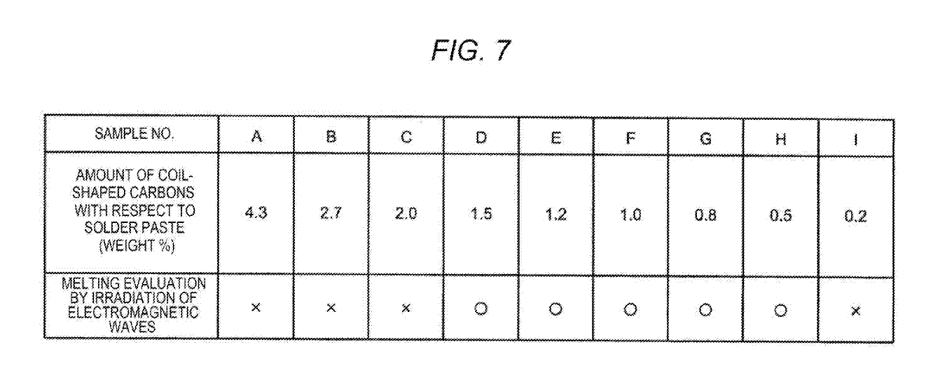

FIG. 7 is a chart showing results of a melting experiment in a proportion of the coil-shaped carbons in the solder material according to the embodiment of the present disclosure. As samples used in the experiment, the coil-shaped carbons 11 were mixed to the solder paste containing Sn—Ab—Bi—In to form samples of paste materials, and the total nine levels of samples A to I were formed by changing the amount of the coil-shaped carbons 11 with respect to the solder paste. In a case where, the proportion of the coil-shaped carbons 11 was low as the sample 1, the number of coil-shaped carbons 11 as the heat generator was small, therefore, the temperature did not reach the solder melting point, and the material was not melted. In cases of the samples A, B and C where the proportion of the coil-shaped carbon 11 was high, the number of coil-shaped carbons 11 existing among the plural metal particles 12 was increased, which prevented the melted metal particles from being agglutinated, as a result, the quality of soldering was deteriorated. When the proportion of the coil carbon 11 was further increased, the material was difficult to be used as the paste. The samples D and E were in a mixed state in which agglutination of solder was confirmed and solder particles were seen in the coil-shaped carbons 11 discharged en the surface. The samples F, G and H were in a state in which almost entire solder was agglutinated and the coil-shaped carbons 11 were discharged from the solder. The discharged coil-shaped carbons 11 need to be washed or coated by a resin and so on in a post-process, however, the quality of soldering is in a good state. According to the result, the proportion of the coil-shaped carbons 11 is desirably0.5 weight % to 1.5 weight % with respect to a weight of the solder paste.

Although the metal particles 12 having the composition of Sn—Ag—Si—In are used in the embodiment, the same advantages can be obtained even when, using a well-known solder material.

The coil-shaped carbons 11 are discharged from the metal particles 12 melted in the soldering process, which can remain in a void after soldering in rare cases. However, thus is the same phenomenon as a void generated in the solder material in related art, and the coil-shaped carbons 11 remaining in the void do not adversely affect the solder quality, and the soldering quality can be maintained.

As described above, according to the embodiment of the present disclosure, the coil-shaped carbons generate heat by irradiating the solder paste formed by mixing the coil-shaped carbons 11 and the solder metal particles 12 with the electromagnetic waves 21, thereby heating and melting the solder metal particles. Accordingly, when soldering electronic components and so on with respect to the thick copper substrate responding to large current, or the high-heat capacity substrate, the solder can be melted before the heat given for soldering is diffused to realize solder bonding. Therefore, it is possible to prevent a situation where the heat given for soldering is diffused to the substrate and the temperature does not reach the melting temperature and a situation where the substrate or components are damaged due to application of high temperature.

Arbitrary embodiments or modification examples in the above various embodiments and modification examples are appropriately combined, thereby obtaining effects possessed by respective examples. It is also possible to combine embodiments with each other, examples with each other or to combine an embodiment with an example, as well as to combine features of different embodiments or examples with each other.

The solder material and the soldering method according to the present disclosure can realize soldering by local, heating using electromagnetic waves, which are useful for soldering not only to the thick copper substrate responding to large current or the high-heat capacity substrate but also to the three-dimensional substrate in which soldering by the soldering iron or flow soldering is difficult or to low-heat resistance components.

What is claimed is:

1. A solder material comprising:
coil-shaped carbons mixed in a solder paste in a proportion of 0.5 weight % to 1.5 weight % with respect to a weight of the solder paste.

2. The solder material according to claim 1,
wherein an inner diameter of each of the coil-shaped carbons is a particle size of 10% or less of a metal and alloy powder.

3. The solder material according to claim 1,
wherein a number of turns of each of the coil-shaped carbons is two or more.

4. The solder material according to claim 2,
wherein the number of turns of the each of the coil-shaped carbons is two or more.

5. The solder material according to claim 1,
wherein a pitch of each of the coil-shaped carbons is 1.1 to 1.82 times as wide as a strand diameter of the each of the coil-shaped carbons.

6. The solder material according to claim 2,
wherein a pitch of the each of the coil-shaped carbons is 1.1 to 1. 82 times as wide as a strand diameter of the each of the coil-shaped carbons.

7. The solder material according to claim 3,
wherein a pitch of the each of the coil-shaped carbons is 1.1 to 1.82 times as wide as a strand diameter of the each of the coil-shaped carbons.

8. The solder material according to claim 4,
wherein a pitch, of the each of the coil-shaped carbons is 1.1 to 1.82 times as wide as a strand diameter of the each of the coil-shaped carbons.
